(19) United States
(12) Patent Application Publication
(10) Pub. No.: US 2025/0170534 A1
(43) Pub. Date: May 29, 2025

(54) HUMIDIFICATION SYSTEM AND METHOD FOR A PROCESS GAS

(71) Applicant: ATS Corporation, Cambridge (CA)

(72) Inventors: David Guiler, Cambridge (CA); Frank Cordovado, Cambridge (CA)

(21) Appl. No.: 18/964,105

(22) Filed: Nov. 29, 2024

Related U.S. Application Data
(60) Provisional application No. 63/603,868, filed on Nov. 29, 2023.

(51) Int. Cl. B01F 23/10; B01F 23/70; B01F 23/80; B01F 25/312; B01F 35/221; B01F 35/71; B01F 101/59; H01M 8/04119; H01M 8/04664

(52) U.S. Cl. CPC B01F 23/191; B01F 23/711; B01F 23/811; B01F 25/31243; B01F 35/2213; B01F 35/718051; H01M 8/04126; H01M 8/04671; B01F 2101/59

(57) ABSTRACT

A humidification system for a process gas uses a plurality of differently sized steam eductors in order to control a relative humidity of a process gas.

### RELATED APPLICATIONS

The current application claims priority to U.S. Provisional Patent Application 63/603,868 filed Nov. 29, 2023, entitled “Humidification System and Method for a Process Gas,” the entire contents of which are incorporated herein by reference in their entirety.

### TECHNICAL FIELD

The current disclosure relates to the humidification of a process gas, and in particular to the humidification of the process gas in a testing environment.

### BACKGROUND

Products can be tested by operating the product under a range of operating conditions to ensure that the product will operate correctly. Additionally or alternatively, the product can be operated under a range of operating conditions in order to determine how the product will operate under those conditions. Regardless, it is desirable to be able to quickly and accurately control the operating conditions in order to efficiently perform the tests.

Proton-Exchange Membrane (PEM) fuel cells are driven by chemical reactions of an anode gas, such as a hydrogen containing gas, and a cathode gas, such as an oxygen containing gas. It is desirable to test the fuel cell under different conditions including different temperatures and humidity levels of both the anode and cathode gases.

Current humidification systems typically allow control of the relative humidity of the gas within a fixed range of humidity levels. Additionally, current systems often provide a relatively slow response time in controlling the relative humidity of the process gases.

An additional, alternative and/or improved system for controlling the relative humidity of a process gas, particularly for use in testing fuel cells is desirable.

### BRIEF DESCRIPTION OF THE DRAWINGS

Further features and advantages of the present disclosure will become apparent from the following detailed description, taken in combination with the appended drawings, in which:

FIG. 1 depicts a humidification system for a process gas according to the present disclosure;

FIGS. 2A and 2B are graphs of the performance of illustrative steam eductors that may be used in a humidification system;

FIG. 3 is a schematic of a fuel cell test system using humidification systems for both the anode and cathode process gasses;

FIG. 4 depicts an implementation of a humidification system for a fuel cell;

FIG. 5 depicts a control process for use in a humidification system;

FIG. 6 depicts an illustrative mixing chamber of the humidification system;

FIG. 7A depicts simulation results of the temperature at different heights within the mixing chamber;

FIG. 7B depicts a graph of simulation results of the temperature at different heights within the mixing chamber;

FIG. 8A depicts simulation results of the relative humidity at different heights within the mixing chamber; and

FIG. 8B depicts a graph of simulation results of the relative humidity at different heights within the mixing chamber.

### DETAILED DESCRIPTION

In accordance with the present disclosure there is provided a humidification system for a process gas comprising: a mixing chamber comprising: a process gas inlet; a process gas outlet; a first steam eductor sized to provide a first range of steam flow rate; and a second steam educator sized to provide a second range of steam flow rate, with a maximum steam flow rate of the second range greater than the maximum steam flow rate of the first range; a first controllable valve connected between the first steam eductor and a steam source; a second controllable valve connected between the second steam eductor and the steam source; and a controller coupled to the first and second controllable valve to independently control a pressure difference across each of the first steam educator and the second steam educator in order to control a relative humidity of the process gas to a desired level between 0% RH and 100% RH when the process gas flows from the process gas inlet to the process gas outlet.

In a further embodiment of the humidification system, the first steam eductor comprises a small steam eductor and the second steam eductor comprises a large steam eductor.

In a further embodiment of the humidification system, the humidification system further comprises one or more additional large steam eductors, to provide a plurality of large steam eductors.

In a further embodiment of the humidification system, the humidification system further comprises a third steam educator sized to provide a third range of steam flow rate between the first range and second range.

In a further embodiment of the humidification system, the third steam eductor provides a medium steam eductor.

In a further embodiment of the humidification system, the small steam eductor is used for a low humidification range of the process gas, the plurality of large steam eductors are used for a higher humidification range of the process gas and the medium steam eductor bridges a humidification range between the small steam eductor and large steam eductor.

In a further embodiment of the humidification system, the controller uses closed loop control to control a mass flow rate of steam injection.

In a further embodiment of the humidification system, the humidification system further comprises a boiler providing the steam source.

In a further embodiment of the humidification system, the humidification system further comprises a steam separator coupled between the boiler and the first and second steam eductors.

In a further embodiment of the humidification system, the humidification system further comprises a pre-heater for pre-heating the process gas prior to entering the process gas inlet.

In a further embodiment of the humidification system, the humidification system further comprises a post heat exchanger for adjusting a temperature of the process gas from the process gas outlet.

In a further embodiment of the humidification system, the mixing chamber has a generally cylindrical shape with the process gas inlet arranged towards a bottom of the mixing chamber and the process gas outlet arranged towards a top of the mixing chamber, and the first steam eductor and the second steam educator arranged within the mixing chamber in proximity of the process gas inlet.

In a further embodiment of the humidification system, the humidification system further comprises one or more features within the mixing chamber to increase mixing of the steam and the process gas.

In accordance with the present disclosure there is further provided a testing system for testing a fuel cell that uses a cathode gas and an anode gas, the testing system comprising: a steam boiler; a cathode humidification system for the cathode gas comprising: a mixing chamber comprising: a cathode gas inlet; a cathode gas outlet; a first steam eductor sized to provide a first range of steam flow rate; and a second steam educator sized to provide a second range of steam flow rate, with a maximum steam flow rate of the second range greater than the maximum steam flow rate of the first range; a first controllable cathode valve connected between the first steam eductor and the steam boiler; and a second controllable cathode valve connected between the second steam eductor and the steam boiler; an anode humidification system for the anode gas comprising: a mixing chamber comprising: an anode gas inlet; an anode gas outlet; a first steam eductor sized to provide a first range of steam flow rate; and a second steam educator sized to provide a second range of steam flow rate, with a maximum steam flow rate of the second range greater than the maximum steam flow rate of the first range; a first controllable anode valve connected between the first steam eductor and the steam boiler; and a second controllable anode valve connected between the second steam eductor and the steam boiler; and a controller coupled to the first and second controllable valve to independently control a pressure difference across each of the first cathode steam educator, the second cathode steam educator, the first anode steam eductor and the second anode steam eductor in order to control a relative humidity of the cathode gas and the anode gas to a desired level between 0% RH and 100% RH.

In a further embodiment of the testing system, wherein the controller uses closed loop control to control a mass flow rate of steam injection into at least one of the cathode gas and the anode gas.

In a further embodiment of the testing system, the testing system further comprises a steam separator coupled between the boiler and the first and second steam eductors.

In a further embodiment of the testing system, the testing system further comprises a pre-heater for pre-heating the process gas prior to entering the process gas inlet.

In a further embodiment of the testing system, the testing system further comprises a post heat exchanger for adjusting a temperature of the process gas from the process gas outlet.

In a further embodiment of the testing system, the mixing chamber has a generally cylindrical shape with the process gas inlet arranged towards a bottom of the mixing chamber and the process gas outlet arranged towards a top of the mixing chamber, and the first steam eductor and the second steam educator arranged within the mixing chamber in proximity of the process gas inlet.

In accordance with the present disclosure there is further provided a method of humidifying a process gas comprising: determining a steam flow rate required to provide a target humidification level to the process gas flowing through a mixing chamber; determining opening amounts for a plurality of valves each controlling steam flow to a respective steam nozzle of a plurality of steam nozzles in the mixing chamber, the plurality of steam nozzles providing a plurality of different ranges of steam flow rates, wherein the determined openings of the plurality of valves controls steam flow to the plurality of nozzles in order to provide the determined steam flow rate; and controlling the plurality of valves according to the determined opening amounts.

A humidification system is described further below that allows the relative humidity of a process gas to be controlled from 0% RH to 100% RH over a wide range of temperatures and process gas flow rates. The humidification system uses direct injection of steam into the process gas stream through a plurality of nozzles of different sizes to span the humidification range. Pressure differences across the nozzles provides a measure of volumetric steam injection. This can be correlated to the mass flow of steam using the known density.

Steam injection into the process gas is done through nozzles that spray steam directly into a mixing chamber through which the process gas flows at a particular rate and pressure. The mixing chamber may include one or more features such as vanes or meshes that facilitate the mixing of the injected steam and gas. The use of multiple nozzles of varying sizes can provide a very fast humidity ramp up response while providing a large range capacity of 0-100% RH for a large range of gas flows. The system can easily be scaled to accommodate large gas flows by the inclusion of additional nozzles in the mixing chamber. For example, it is possible to provide relative humidity from 0% RH to 100% RH at temperatures from 35° C. to 90° C. for process gas flows from about 24 SLPM (Standard Liters Per Minute) to over 8000 SLPM.

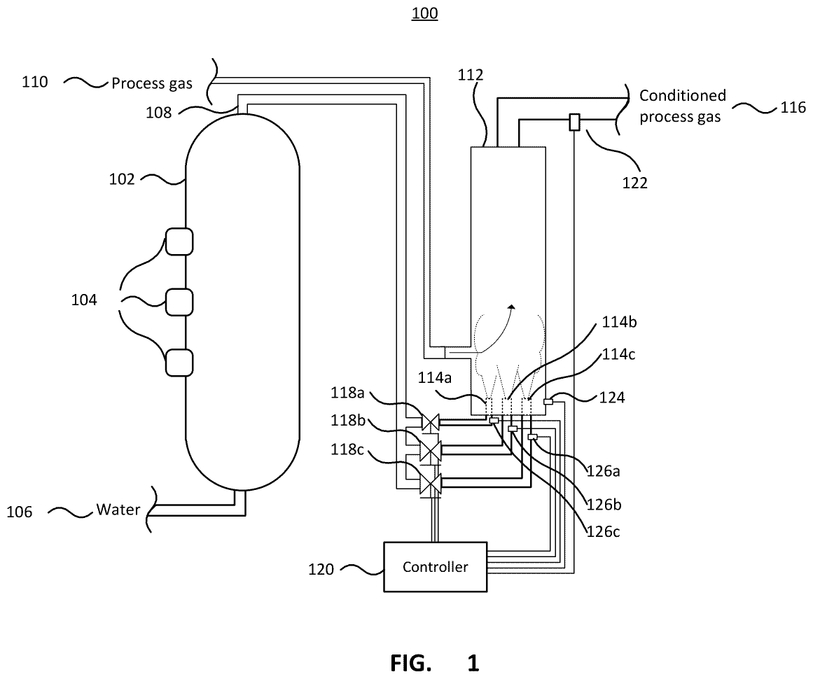

FIG. 1 depicts a humidification system for a process gas according to the present disclosure. The humidification system 100 depicted in FIG. 1 includes a steam generator 102 that has one or more heating elements 104 that can boil incoming water 106, which may be deionized water, to generate a steam flow at the output 108 of the generator

A process gas 110 flows into a mixing chamber 112 that includes a plurality of steam nozzles 114a, 114b, 114c that can each inject steam into the mixing chamber 112. The steam and the process gas can be mixed within the mixing chamber 112 to output the conditioned process gas 116. The conditioned process gas 116 is conditioned to have a desired relative humidity level.

In order to provide the desired humidity level to the process gas, the steam flow to each of the nozzles is individually controlled by a respective valve 118a, 118b, 118c. The nozzles 114a, 114b, 114c may be of differing sizes. For example, nozzle 114a may be a small nozzle, nozzle 114b may be a medium nozzle and nozzle 114c may be a large nozzle. It is noted that not all of the nozzles need to be of different sizes. For example, nozzle 114a may be a small nozzle and nozzles 114b and 114c may each be a large nozzle. Each valve 118a, 118b, 118c is sized appropriately for the nozzle that the valve controls.

In controlling the humidity of the process gas, a certain amount of steam will need to be injected into the mixing chamber. The amount of steam that needs to be injected depends upon the volume flow of the process gas and the desired relative humidity of the conditioned process gas. The individual valves can be controlled, i.e. open/closed a desired amount, to provide a certain steam flow into the mixing chamber. The total steam flow is the sum of the individual steam flows.

A controller 120 can control the valves 118a, 118b, 118c in order to provide the required steam flow to provide a desired relative humidity. The relative humidity of the conditioned process gas can be measured by a sensor 122. The controller 120 may use various techniques to control the relative humidity, including both open loop control, in which an amount of steam required to be injected can be calculated based on various parameters of the process gas such as its temperature, pressure, and flow rate. Once the amount of steam to inject is determined, the amount each valve should be opened can be determined and the valves actuated accordingly. Additionally or alternatively, the controller 120 may use a closed-loop control, such as a PID control process, to monitor the actual relative humidity in the conditioned process gas 116 and control the valves in order to maintain the relative humidity at the desired level.

The steam flowing from a single nozzle can be determined from the pressure difference across the nozzle. The pressure difference may be determined using pressure sensors including a pressure sensor measuring the pressure at the outlet of the nozzle, or the in the mixing chamber 124 as well as individual pressure sensors 126a, 126b, 126c. Pressure differences across the nozzles provides a measure of volumetric steam injection. This can be correlated to the mass flow of steam using the known density.

As described above, different size nozzles are used in order to be able to control the relative humidity over a large range. For example, a small nozzle, or a plurality of small nozzles, can be used in order to provide relative humidity at a low end of the range, such as from 0% RH to 20% RH. A large nozzle, or plurality of nozzles, can provide relative humidity at higher ranges of relative humidity such as from 20% RH to 100% RH. It will be appreciated that the particular arrangement of nozzles used can depend upon the particular flow characteristics of the nozzles, the range of flow rates of the process gas required, or desired, the range of relative humidity required or desired as well as the range of temperatures required or desired.

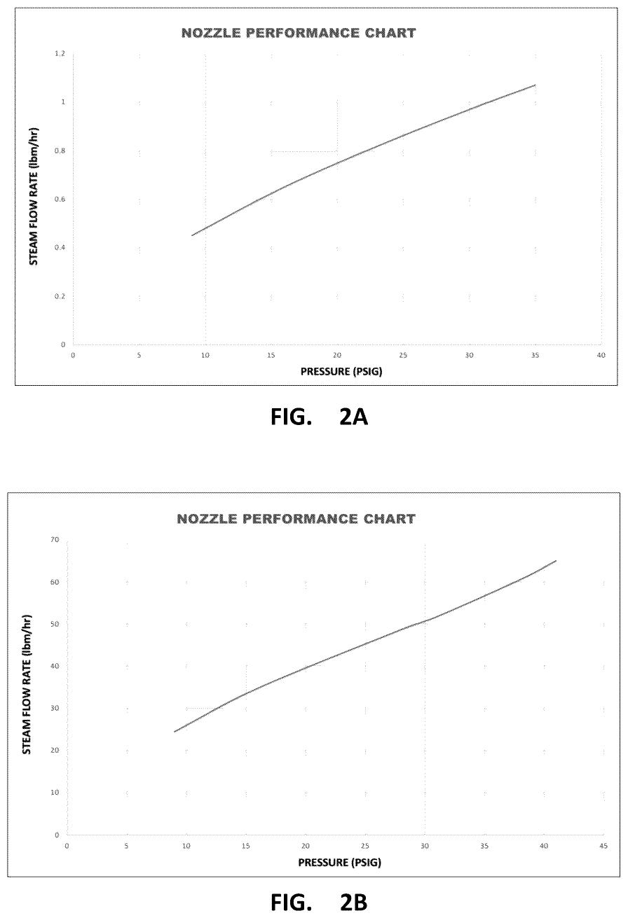

FIGS. 2A and 2B are graphs of the performance of illustrative steam eductors that may be used in a humidification system. Different nozzles may have an operating range of pressure differences. FIG. 2A depicts the nozzle performance for a small nozzle, which may be a steam eductor such as a SP46550-1/4ME provided by Spraying Systems Co.®. As depicted, when the pressure across the nozzle is approximately 10 PSIG, the steam flow rate is about 0.5 lbm/hr. As the pressure difference across the nozzle increases, the flow rate increases. For example at a pressure difference of 35 PSIG, the steam flow rate is approximately 1.1 lbm/hr. Above 15 PSIG the flow becomes sonic and the pressure vs. steam flow rate is linear. FIG. 2B depicts the nozzle performance for a large nozzle, which may be a steam eductor such as a 46550-1/4ME provided by Spraying Systems Co.®. As depicted, when the pressure across the nozzle is approximately 10 PSIG, the steam flow rate is about 25 lbm/hr. As the pressure difference across the nozzle increases, the flow rate increases. For example at a pressure difference of 35 PSIG, the steam flow rate is approximately 65 lbm/hr.

As can be seen from the graphs of FIGS. 2A, 2B, the maximum flow rate of the small nozzle, is less than the minimum flow rate of the large nozzle. This gap in the flow rate could result in a range of humidities that cannot be achieved. If the ranges of humidities that cannot be achieved by the small and large nozzles alone are desirable, the gap in the flow rate can be bridged using additional small nozzles, or possibly additional nozzles of different sizes. In the example of FIGS. 2A, 2B approximately 20 small nozzles could be used to provide a full range of the flow rate. That is the sum of the maximum flow rate of all 20 small nozzles would be greater than the minimum flow rate of the large nozzle, and as such the nozzles can be controlled to provide a continuous range of humidities. Rather than using the relatively large number of small nozzles, one or more medium size nozzles can be used to bridge the flow rates between the maximum flow rate of the small nozzles and the minimum flow rate of the large nozzle. It will be appreciated that various different numbers and sizes of nozzles can be used depending upon the required flow rates of the process gas, humidity levels and temperatures.

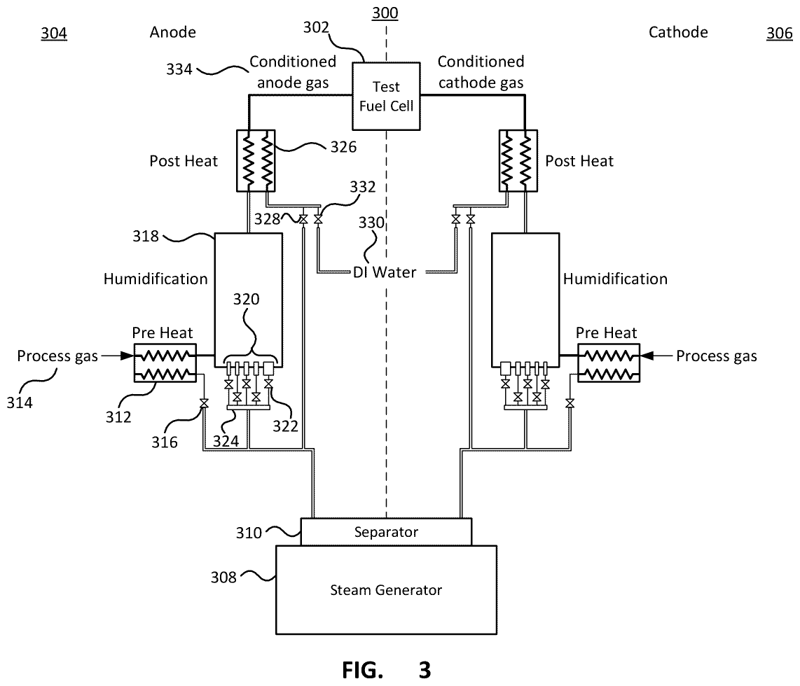

FIG. 3 is a schematic of a fuel cell test system using humidification systems for both the anode and cathode process gasses. It is noted that not all of the components of the system are depicted in FIG. 3 such as return/supply lines, valves, safety devices, etc., which are omitted for clarity of the figure. The fuel cell test system 300 allows the operation of a fuel cell 302 to be tested with a wide range of conditions for the anode and cathode gasses. The fuel cell test system 300 comprise an anode conditioning branch 304 and a cathode conditioning branch 306 for conditioning the anode and cathode gasses respectively. The anode and cathode conditioning branches 304 are depicted as substantially the same, and only the operation of the anode conditioning branch is described in further detail. It will be appreciated that the cathode conditioning branch may function in a similar manner as the anode processing branch.

A steam generator 308 boils de-ionized water to generate steam. The generated steam may pass through one or more steam separators 310 in order to provide high quality fully saturated steam. The steam generated from the generator 308 may be supplied to both the anode and cathode conditioning branches. The steam is used for humidifying the respective process gasses as well as possibly heating the process gas.

The generated steam is provided to a pre-heater 312 that receives the process gas and pre-heats it to elevate the temperature. The pre-heater 312 is depicted as a heat exchanger with the heat provided by the generated steam. The process gas 314 enters the pre-heater 312 and is heated by the steam. The flow of the steam through the heat exchanger, which can affect the heating of the process gas 314, can be controlled by a valve 316. The flow of the process gas can be also be controlled by one or more control devices, such as valves (not shown) depending upon the flow rate required by the fuel cell being tested. Although a pre-heater is depicted, it may be omitted.

The process gas, whether pre-heated or not, is provided to a humidifier 318. The humidifier comprises a mixing chamber through which the process gas flows and is humidified to a particular relative humidity range. The relative humidity that can be achieved by the system can be from 0% RH to 100% RH. The ability to achieve a range of relative humidity levels depends on the ability to provide the steam flow at the appropriate rate to achieve the required humidity levels. As depicted, the humidifier 318 comprises a plurality of steam nozzles 320 that each inject steam into the mixing chamber of the humidifier. The injected steam mixes with the process gas in order to provide the desired humidity. The minimum flow rate of the smallest nozzle of the system will inject the least steam into the mixing chamber and so will determine the minimum humidity range possible, which will also depend upon the flow rate of the process gas. The maximum humidity achievable will be dependent upon the steam flow provided by all of the nozzles operating at their maximum flow rate. The nozzles 320 may be steam eductors which will provide a certain flow rate based on the pressure difference across the nozzle.

Each of the nozzles is independently controlled by a respective valve 322, which connects to a steam manifold 324 or other means of connecting to the steam source. The valves may be sized according to the respective nozzle they are connected to in order to ensure that the valve can sustain the maximum flow of the steam of the nozzle. The individual valves 322 may be controlled by a controller (not shown) using various different control techniques. For example, the controller may use an open loop control technique in which the controller determines an amount of steam that needs to be injected into the mixing chamber to provide the process gas with the desired humidity level. The amount of steam required may depend upon the flow rate of the process gas, as well as the temperature and/or pressure of the process gas, and the desired humidity level. Once the steam flow required is determined, the controller can determine the amount to open each of the individual valves/nozzles to provide the flow rate. The controller may monitor pressure differences across each of the nozzle in order to determine the amount of steam injected into the mixing chamber. Further, the controller may use a closed loop control technique, which may be based on a PID (Proportional, Integral, Derivative) controller. The closed loop technique uses feedback of the actual relative humidity of the conditioned process gas in order to control the amount of steam injected into the mixing chamber in order to achieve the desired humidity levels. The closed loop controller may determine an amount of steam to inject into the mixing chamber and again the controller may determine how to operate the valves/nozzles in order to provide the appropriate steam flow.

The humid process gas may be provided from the humidifier 318 to a post-heat conditioner 326 that can either heat or cool process gas in order to achieve a desired process gas temperature at the fuel cell 302. The post-heat conditioner 326 is depicted as a single heat exchanger that may provide either steam to the conditioner under control of a valves 328, or may provide cooling de-ionized water 330, or other cooling source, under control of a valve 332. The post-heat conditioner adjusts the temperature of the conditioned gas to either raise or lower the temperature to the desired or required temperature. Although a post-heater is depicted, it may be omitted.

The fuel cell test system depicted in FIG. 3 uses multiple nozzles of different sizes to provide a humidifier that is capable of providing a wide range of humidity levels over a wide range of process gas flow rates and temperatures. Further, the use of multiple different sized nozzles for the direct steam injection allows a rapid response for delivering desired humidity levels. Such rapid response may be useful in testing in which it is desirable to perform different tests under different conditions.

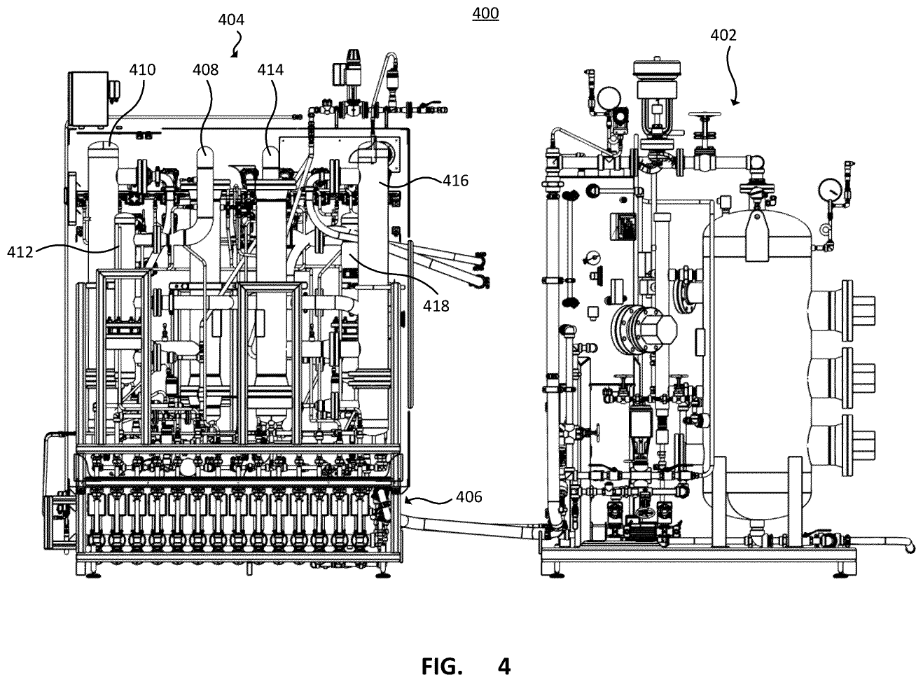

FIG. 4 depicts front view of an implementation of a humidification system for a fuel cell. The system 400 comprises steam generator components 402 that generate steam and provide it to the conditioning system 404. The steam generator 402 may receive water from a water source as well as from dropouts or recirculation from other components of the system. The steam is provided to the conditioning system 404 which comprises a number of valves 406 for controlling the flow of steam to different components. The humidifier 404 may comprise both an anode branch and a cathode branch. Alternatively, the humidifier may comprise as many branches required for a particular application. As depicted an anode humidifier mixing chamber 408 may receive pre-heated anode gas from a pre-heater 410 and provides the humidified anode gas to a post conditioner 412 that may either further heat or cool the humidified gas which can be provided to the fuel cell being tested. The post conditioner 412 may receive the steam and/or cooling water. The humidifier 404 as depicted also includes a cathode humidifier mixing chamber that receives the cathode gas from a pre-heater 416 and provides the humidified gas to a post conditioner 418.

It will be appreciated that the particular humidification system depicted in FIG. 4 may be used for applications besides a fuel cell test system as described herein.

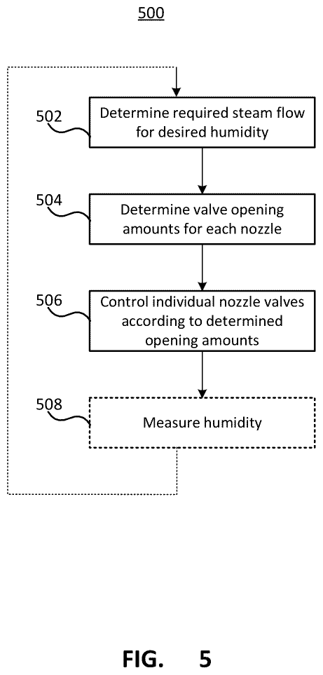

FIG. 5 depicts a control process for use in a humidification system. The method 500 may be performed by a controller or computing device. The method 500 determines a required amount of steam or steam flow rate for a desired humidity (502). The desired humidity may be specified in various ways and provides a target humidity for the process gas being conditioned. The desired humidity may be specified for a target temperature. The steam flow required may also be determined based on the flow rate of the process gas being humidified. Further, the determination of the required steam flow may be done use open-loop or closed-loop control techniques. Once the required steam rate is determined, the valve opening amounts can be determined (504) for each of the individual valves associated with respective steam nozzles. The valve opening amounts are determined in order to provide the determined steam amount or steam flow rate from the combination of the individual nozzles. The individual valves are then controlled according to the determined opening amounts (506). The pressure difference across the valve can be monitored which can be correlated to the steam flow rate for each nozzle in order to ensure the correct amount of steam is injected into the mixing chamber. For closed loop controls, the humidity levels of the conditioned process gas can be measured (508) and used as feedback to determine the required steam flow to adjust the humidity of the process gas to the desired levels. For open-loop control techniques, it may not be necessary to measure the humidity level for feedback, although it could be measured for other purposes.

As described above, the desired flow rates for each nozzle may be determined and the individual valves associated with each nozzle controlled in order to provide the desired steam flow. The control of the individual valves may also be done using either an open loop control, in which the position of the valve is determined based on the required flow, and controlled accordingly. Additionally, or alternatively, the valve control may use a closed-loop control to control the valve to provide the desired steam flow. As described above, the pressure difference across a nozzle can be correlated to the steam flow, and as such, the valve can be controlled to maintain the pressure difference across the valve at the required pressure difference to provide the required steam flow.

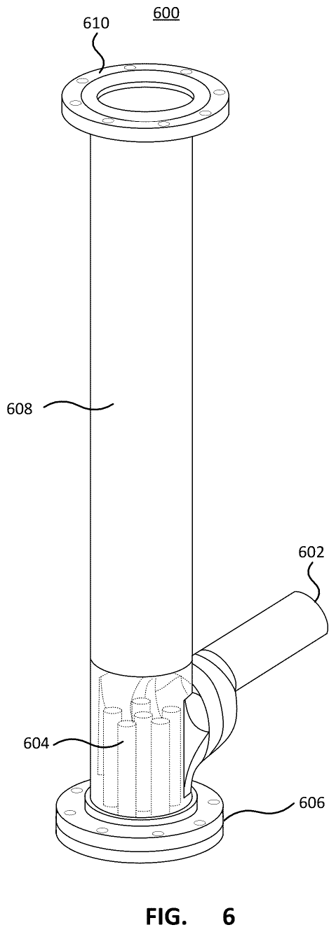

FIG. 6 depicts an illustrative mixing chamber of the humidification system. The mixing chamber 600 may be used in the humidifiers described above. The mixing chamber 600 comprises a gas inlet 602 for receiving the process gas to be humidified. A plurality of different sized steam nozzles 604 are arranged within the mixing chamber towards a bottom of the chamber. The interior of the mixing chamber with the steam nozzles are depicted in dotted lines. The mixing chamber 600 may include a mounting flange 606 or similar structure at the bottom which may allow the nozzles to be removably mounted to the mixing chamber. Each of the individual nozzles will have a respective connection to control valves, which are not depicted in FIG. 6. The injected steam from the nozzles and the process gas flowing through the inlet 602 flow within a mixing section 608 towards a gas outlet 610 which can be connected to downstream processes. The mixing section 608 may include one or more features for increasing the mixing of the steam and the process gas. For example, one or more vanes or turbulent devices, wire meshes or screens may be located within the mixing chamber. The outlet of the mixing chamber 610 may include a flange or similar structure for mounting to piping or other devices.

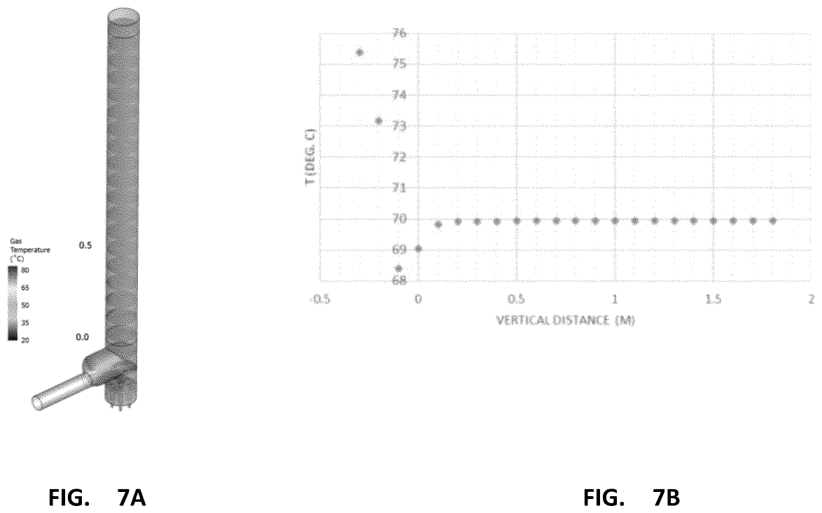

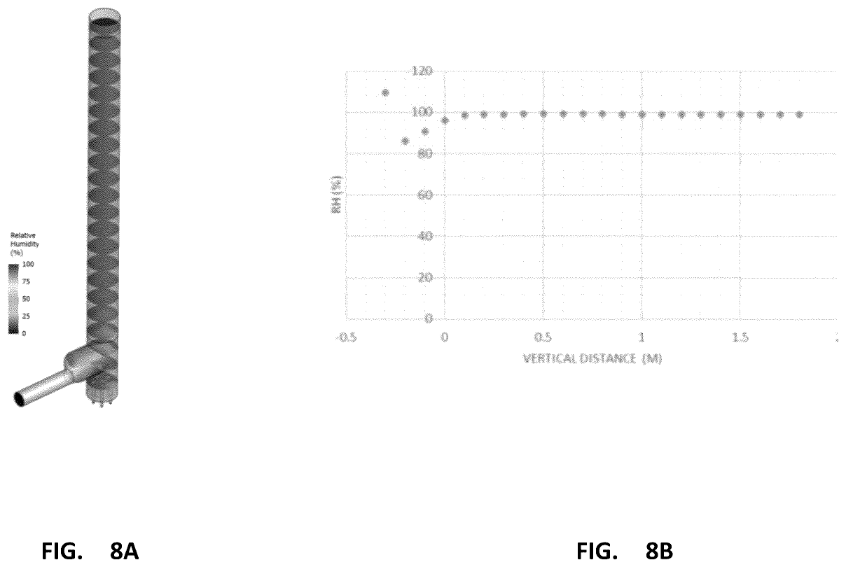

Simulations of performance of the mixing chamber depicted in FIG. 6 were performed in order to determine the temperatures and relative humidity levels of a process gas at different heights through the mixing chamber. The results are depicted in FIGS. 7A-8B below.

FIG. 7A depicts simulation results of the temperature at different heights within the mixing chamber. FIG. 7B depicts a graph of simulation results of the temperature at different heights within the mixing chamber. FIG. 8A depicts simulation results of the relative humidity at different heights within the mixing chamber. FIG. 8B depicts a graph of simulation results of the relative humidity at different heights within the mixing chamber. As can be seen from the simulation results, both the temperature and humidity levels of the process gas are consistent through most of the chamber. The chamber simulated was approximately 2 meter in height. It is possible to reduce or increase the height of the mixing chamber.

The above has described a humidification system that can quickly provide a desired humidity level to a process gas. The humidification system uses multiple different sized steam injection nozzles in order to be able to achieve a wide range of relative humidity levels. Humidity levels from 0% RH to 100% RH may be achieved for a wide range of process gas temperatures and flow rates. While the humidification system was described above with particular reference to its use in a testing system for a fuel cell, similar humidification systems can be used in a variety of different applications. For example, applications for the humidification system may include humidifying calibration gasses, particle and aerosol streams, and air used in processes such as gas blending, gas testing, and gas process equipment.

It will be appreciated by one of ordinary skill in the art that the systems, methods and components shown in the figures can include components not explicitly depicted. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A humidification system for a process gas comprising:
a mixing chamber comprising:
a process gas inlet;
a process gas outlet;
a first steam eductor sized to provide a first range of steam flow rate; and
a second steam educator sized to provide a second range of steam flow rate, with a maximum steam flow rate of the second range greater than the maximum steam flow rate of the first range;
a first controllable valve connected between the first steam eductor and a steam source;
a second controllable valve connected between the second steam eductor and the steam source; and
a controller coupled to the first and second controllable valve to independently control a pressure difference across each of the first steam educator and the second steam educator in order to control a relative humidity of the process gas to a desired level between 0% RH and 100% RH when the process gas flows from the process gas inlet to the process gas outlet.

2. The humidification system of claim 1, wherein the first steam eductor comprises a small steam eductor and the second steam eductor comprises a large steam eductor.

3. The humidification system of claim 2, further comprising one or more additional large steam eductors, to provide a plurality of large steam eductors.

4. The humidification system of claim 3, further comprising a third steam educator sized to provide a third range of steam flow rate between the first range and second range.

5. The humidification system of claim 4, wherein the third steam eductor provides a medium steam eductor.

6. The humidification system of claim 5, wherein the small steam eductor is used for a low humidification range of the process gas, the plurality of large steam eductors are used for a higher humidification range of the process gas and the medium steam eductor bridges a humidification range between the small steam eductor and large steam eductor.

7. The humidification system of claim 1, wherein the controller uses closed loop control to control a mass flow rate of steam injection.

8. The humidification system of claim 1, further comprising a boiler providing the steam source.

9. The humidification system of claim 8, further comprising a steam separator coupled between the boiler and the first and second steam eductors.

10. The humidification system of claim 1, further comprising a pre-heater for pre-heating the process gas prior to entering the process gas inlet.

11. The humidification system of claim 1, further comprising a post heat exchanger for adjusting a temperature of the process gas from the process gas outlet.

12. The humidification system of claim 1, wherein the mixing chamber has a generally cylindrical shape with the process gas inlet arranged towards a bottom of the mixing chamber and the process gas outlet arranged towards a top of the mixing chamber, and the first steam eductor and the second steam educator arranged within the mixing chamber in proximity of the process gas inlet.

13. The humidification system of claim 1, further comprising one or more features within the mixing chamber to increase mixing of the steam and the process gas.

14. A testing system for testing a fuel cell that uses a cathode gas and an anode gas, the testing system comprising:
a steam boiler;
a cathode humidification system for the cathode gas comprising:
a mixing chamber comprising:
a cathode gas inlet;
a cathode gas outlet;
a first steam eductor sized to provide a first range of steam flow rate; and
a second steam educator sized to provide a second range of steam flow rate, with a maximum steam flow rate of the second range greater than the maximum steam flow rate of the first range;
a first controllable cathode valve connected between the first steam eductor and the steam boiler; and
a second controllable cathode valve connected between the second steam eductor and the steam boiler;
an anode humidification system for the anode gas comprising:
a mixing chamber comprising:
an anode gas inlet;
an anode gas outlet;
a first steam eductor sized to provide a first range of steam flow rate; and
a second steam educator sized to provide a second range of steam flow rate, with a maximum steam flow rate of the second range greater than the maximum steam flow rate of the first range;
a first controllable anode valve connected between the first steam eductor and the steam boiler; and
a second controllable anode valve connected between the second steam eductor and the steam boiler; and
a controller coupled to the first and second controllable valve to independently control a pressure difference across each of the first cathode steam educator, the second cathode steam educator, the first anode steam eductor and the second anode steam eductor in order to control a relative humidity of the cathode gas and the anode gas to a desired level between 0% RH and 100% RH.

15. The testing system of claim 13, wherein the controller uses closed loop control to control a mass flow rate of steam injection into at least one of the cathode gas and the anode gas.

16. The testing system of claim 14, further comprising a steam separator coupled between the boiler and the first and second steam eductors.

17. The testing system of claim 13, further comprising a pre-heater for pre-heating the process gas prior to entering the process gas inlet.

18. The testing system of claim 13, further comprising a post heat exchanger for adjusting a temperature of the process gas from the process gas outlet.

19. The humidification system of claim 1, wherein the mixing chamber has a generally cylindrical shape with the process gas inlet arranged towards a bottom of the mixing chamber and the process gas outlet arranged towards a top of the mixing chamber, and the first steam eductor and the second steam educator arranged within the mixing chamber in proximity of the process gas inlet.

20. A method of humidifying a process gas comprising:
determining a steam flow rate required to provide a target humidification level to the process gas flowing through a mixing chamber;
determining opening amounts for a plurality of valves each controlling steam flow to a respective steam nozzle of a plurality of steam nozzles in the mixing chamber, the plurality of steam nozzles providing a plurality of different ranges of steam flow rates, wherein the determined openings of the plurality of valves controls steam flow to the plurality of nozzles in order to provide the determined steam flow rate; and
controlling the plurality of valves according to the determined opening amounts.
